(19) United States
(12) Patent Application Publication
(10) Pub. No.: US 2012/0218564 A1
(43) Pub. Date: Aug. 30, 2012

(54) METHOD FOR THE SECURE DETECTION AND POSITION DETERMINATION OF OBJECTS AND SAFETY APPARATUS

(75) Inventors: Martin WÜSTEFELD, Sexau (DE); Ralph RAPP, Endingen (DE)

(73) Assignee: SICK AG, Waldkirch (DE)

(21) Appl. No.: 13/372,578

(22) Filed: Feb. 14, 2012

(30) Foreign Application Priority Data
Feb. 24, 2011 (EP) 11155891.2

(51) Int. Cl. G01B 11/14

(52) U.S. Cl. 356/614

(57) ABSTRACT

The invention relates to a method for the safe detection and position determination of objects by means of an optoelectronic scanner. In this method an external reference target is provided in the field of vision and the actual signal level of the reflections from the reference target is detected. A desired degree of reflection of the reference target is calculated from the measured distance from the reference target, from a scanner-specific distance-dependent reception characteristic of the light receiver and from the currently measured received signal on the reference target. Since the degree of reflection of the reference target is not fixedly predefined and is e.g. not taught, but is rather fixed by the aforesaid calculation on the putting into operation, the safety apparatus in accordance with the invention has an exactly defined detection capability even if soft targets such as fog, rain, snow or other air pollution are present.

The invention relates to a method for the secure detection and position determination of objects in a monitored zone by means of an optoelectronic scanner comprising the steps of: transmitting a transmitted light beam using a light transmitter; and periodic scanning of a field of vision of the scanner including the monitored zone by the transmitted light beam via a deflection unit; receiving the transmitted light beam reflected at objects in the field of vision using a light receiver and providing received signals whose signal levels correspond to the received light intensities; outputting a safety signal (warning signal or switch-off signal) when an unpermitted object is detected in the monitored zone in that the corresponding received signal is above a received signal threshold; providing an external reference target in the field of vision; detecting the actual signal level of the reflections from the reference target. The invention further relates to a safety apparatus for carrying out the method.

Laser safety scanners such as are known from DE 43 40 756 A1 are frequently used for monitoring work spaces. A light beam generated by a laser is directed via a light deflection unit into a protected zone and is remitted there by an object which may be present. At least some of the remitted light again returns to the laser scanning unit and is detected by a receiver there. The light deflection unit is designed to be pivotable or rotatable as a rule such that the light beam generated by the laser sweeps over a protective field generated by the pivot movement or rotation movement. If a light signal remitted by the object is received from the protected zone, a conclusion can be drawn on the angular location of the object in the protected zone from the angular position of the deflection unit. If the transit time of individual laser light pulses is, for example, additionally monitored from the transmission up to the reception of a reflection at the object, it is additionally possible to draw a conclusion on the distance of the object from the laser scanner from the transit time using the speed of light. The location of the object can be determined using the statements on angle and distance and the scan plane swept over by the light beam can be completely monitored. If an unpermitted object is located in the scan plane, a corresponding warning signal or stop signal can be output by the evaluation unit of the scanner.

Such systems are used, for example, at machines in which a danger zone has to be monitored which may not be entered by an operator during the operation of the machine. If an unpermitted object—that is, for example, a leg of an operator—is detected in the danger zone with the help of the laser scanner, an emergency stop of the machine is effected. Such scanning systems as safety sensors have to work reliably and must therefore satisfy high safety demands, for example the EN13849 standard for machine safety and in particular the device standard EN61496 for protective devices working in a contactless manner (ESPE=electro sensitive protective equipment).

A number of measures have to be taken to satisfy these safety standards such as reliable electronic evaluation by redundant, diverse electronics, function monitoring by, for example, monitoring the soiling of optical components, in particular of a front screen, and/or provision of individual test targets with defined degrees of reflection which have to be recognized at the corresponding scanning angles.

Such safety laser scanners are also used at so-called DTS (“driverless transport systems”) to prevent these transport systems from colliding with objects such as persons which cross their route. Since the collision danger is speed dependent, the laser scanner has adaptable protected field dimensions which can be switched in dependence on the vehicle speed or can be changed in another manner.

In the indoor sector in which no sight interference occurs from the outside, the named measured are sufficient to satisfy the safety standards. The use of safety scaners has previously been very problematic in the outdoor sector. The useful optical performance is reduced by an unknown degree, and thus the detection reliability is reduced, by rain, fog, snow air pollution and the like which will be called “soft targets” in the following. This results in an unpredictable erroneous response of the scanner, for example due to transmission radiation which is reflected at the soft targets and is interpreted as an “object in the protected zone” by the scanner as soon as the backscattered signal is above an assessment threshold. It is a further disadvantage that, when soft targets occur, the transmission radiation is attenuated and thus the visual range is reduced by an unknown degree so that objects in the protected zone will possibly not be recognized.

A scanner is known from DE 39 08 273 C1 in which the detection ability can be ensured by monitoring the positions of a plurality of offset external test targets having defined degrees of reflection.

The disadvantage of this is that the variation of the degree of reflection of the external test target and the accompanying variation of the detection capability in the case of the occurrence of soft targets is not revealed. Essentially only a check is made whether no light is received in the zones in which an absorber is located as a test target and whether light is received in those zones in which reflectors are provided. Variations in the degree of reflection of the test targets and accompanying variations in the detection capability in the case of the occurrence of internal errors of the scanner such as a drop in transmission power or an increase in the evaluation thresholds are not revealed. The necessary use of test targets designed specifically for the scanner is a further disadvantage. The test targets must also be located at a predefined distance from the scanner.

Further scanners in accordance with the preamble of claim 1 are also known from EP 0 520 247 A2, U.S. Pat. No. 6,188,319 B1, EP 0 967 492 A1 and GB 2 424 272 A.

Starting from this prior art, it is the object of the invention to avoid the named disadvantages and to provide an improved method and a safety apparatus with which a reliable detection capability is possible, in particular in outdoor use.

This object is satisfied by a method having the features of claim 1 and by a safety apparatus having the features of claim 7.

The method in accordance with the invention for the secure detection and position determination of objects in a monitored zone by means of an optoelectronic scanner includes the steps:
transmitting a transmitted light beam using a light transmitter and periodic scanning of a field of vision of the scanner including the monitored zone using the transmitted light beam via a deflection unit;
receiving the transmitted light beam reflected at objects in the field of vision using a light receiver and providing received signals whose signal levels correspond to the received light intensities;
outputting a safety signal (warning signal or switch-off signal) when an unpermitted object is detected in the monitored zone in that the corresponding received signal is above a received signal threshold;
providing an external reference target in the field of vision;
detecting the actual signal level of the reflections from the reference target;
calculating a desired degree of reflection of the reference target from the measured distance from the reference target, from a scanner-specific distance-dependent reception characteristic of the light receiver and from the currently measured received signal on the reference target on the putting into operation, with the desired degree of reflection corresponding to a desired signal level of the reference target;
outputting an error signal when a falling below of the desired signal level is recognized during normal operation.

The particular advantage of the method in accordance with the invention comprises a defined detection capability of the scanner even on the presence of soft targets such as occur in the outdoor region. In this respect, the reference target can be located at any desired distance from the scanner for the scanner determines the desired degree of reflection itself on being put into operation. The availability is thereby increased and in particular defined overall, in particular in outdoor use. Due to the internal scanner reference determination, natural surfaces can also be used as a reference target, whereby putting-in-operation efforts of the customers can be dispensed with such as an installation of reference targets and/or geometrical demands and positional demands on the reference target.

If the distance of the reference target is taken into account, the reference target can be arranged at any desired distance from the scanner. The desired degree of reflection of the reference target is calculated from the measured distance from the reference target, from a scanner-specific, distance-dependent reception characteristic of the light receiver and from the currently measured received signal on the reference target. The desired degree of reflection is therefore not taught.

It is particularly sensible that, on the determination of the desired degree of reflection, a minimum degree of reflection of objects to be detected is taken into account which in particular amounts to 2%, as it is then ensured that when the reference target is recognized, it is also always ensured that objects are detected.

In a further development of the invention, the position of the reference target is monitored so that no manipulations can be carried out even after putting into operation.

In an embodiment of the invention, the reference target itself is formed by an object to be monitored. Such an embodiment is naturally only sensible when the object is constantly in the monitored zone. This embodiment then has the advantage, however, that so-to-say a visual range determination takes place with the observation in accordance with the invention of the degree of reflection of the reference target and thus safety parameters such as the extent of the monitored zone can be adapted to the current visual range.

A safety apparatus in accordance with the invention for a method in accordance with the invention has a scanner having a light transmitter for transmitting a transmitted light beam, a deflection unit for the periodic scanning of a field of vision of the scanner including the monitored zone by the transmitted light beam, having a light receiver for receiving the transmitted light beam reflected at objects in the field of vision and for providing received signals whose signal levels correspond to the received light intensities and having an evaluation unit for processing the received signals and for outputting a safety signal (warning signal or switch-off signal) when an unpermitted object is detected in the monitored zone in that the corresponding received signal is above a received signal threshold. An external reference target is located in the field of vision. The evaluation unit furthermore has a signal level determination unit for determining the actual signal level of the reflections from the reference target, a determination unit for the degree of reflection for calculating a desired degree of reflection of the reference target from the measured distance from the reference target, a scanner-specific, distance-dependent reception characteristic of the light receiver and from the currently measured received signal on the reference target on the putting into operation, with the desired degree of reflection corresponding to a desired signal level of the reference target. The evaluation unit furthermore has an output unit for outputting an error signal if a deviation from the desired signal level of the reference target is recognized during working operation.

In a further development of the invention, the reference target comprises at least one element mechanically bounding the monitored zone. Such elements are mostly always present, for example in the form of housing walls or a base.

It would also be conceivable that the reference target has a retroreflector.

The reference target should be at least as large as the geometrical resolving power of the scanner so that the reference target can also always be reliably recognized.

The invention will also be explained in the following with respect to further advantages and features with reference to the enclosed drawing and to embodiments. The Figures of the drawing show in:

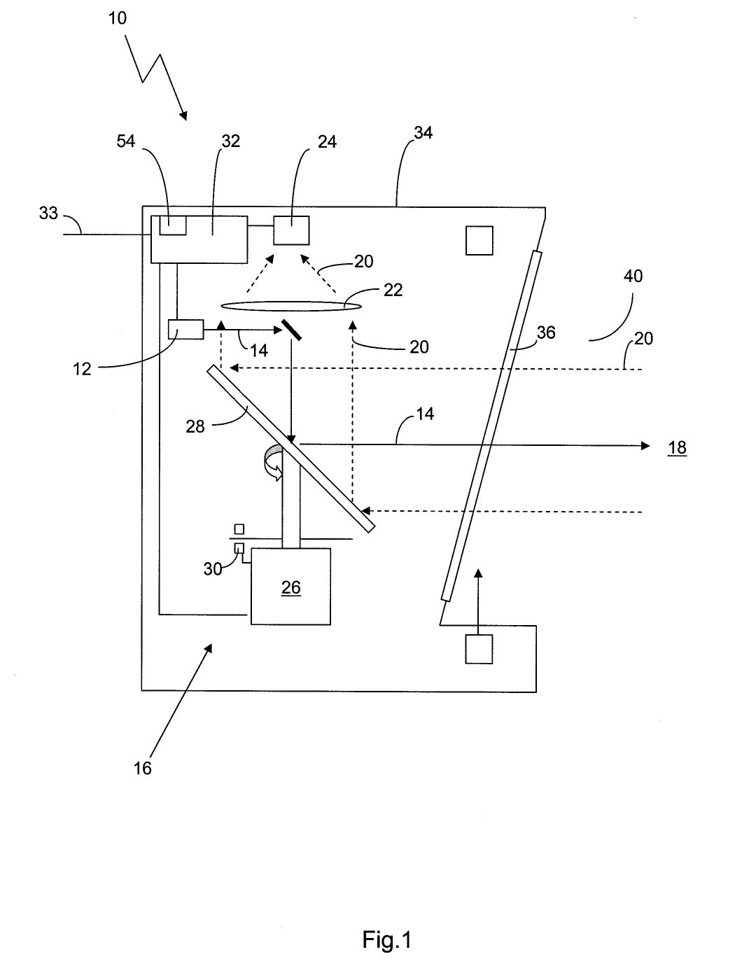

FIG. 1 a schematic representation of a laser scanner in accordance with the invention;

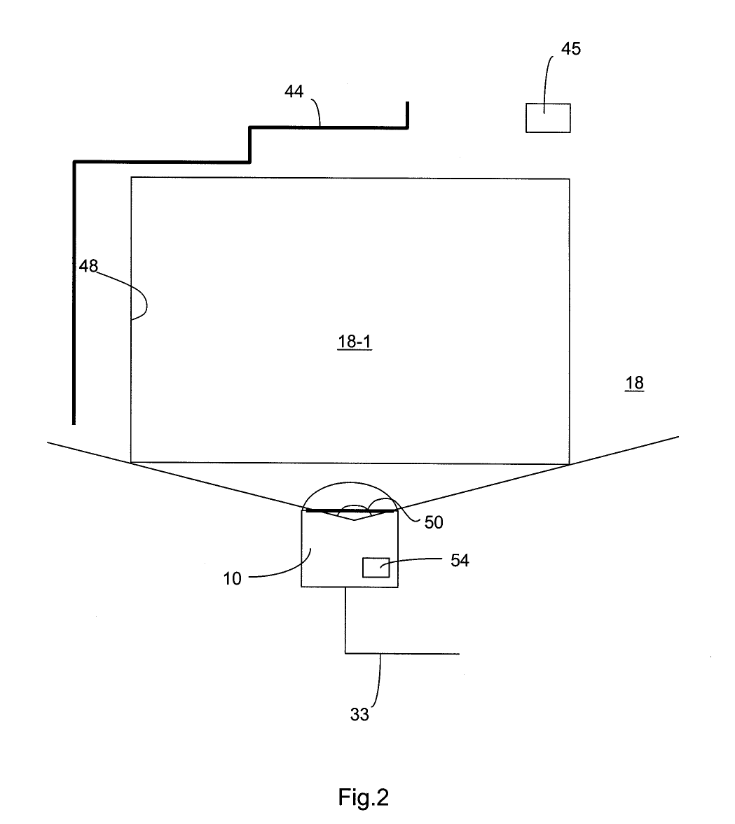

FIG. 2 a safety apparatus in accordance with the invention; and

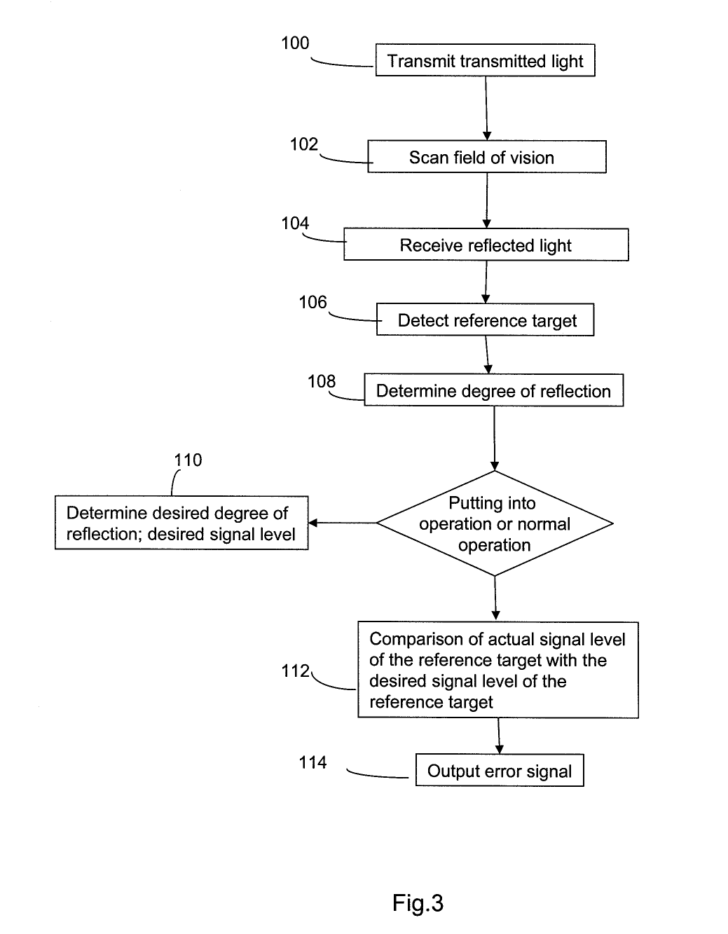

FIG. 3 a schematic flowchart of the method in accordance with the invention.

The safety apparatus described in the following includes a laser scanner and serves, for example, for monitoring any unauthorized access into a monitored zone. For example, the area of danger of a crane, of a wood processing machine or the like can be monitored into which no operator may penetrate during operation. Or the region in front of an autonomously driving vehicle can be monitored and more of the same. If an unpermitted object, for example the leg of an operator, is located in the monitored zone, this is detected by the described scanner and a safety signal, which can be a warning signal or a switch-off signal, can be output and the movement causing danger can be stopped or at least braked.

The term “unpermitted object” is used in the present test for unpermitted or interfering objects in the protected field. Endangered body parts of operators can in particular also be meant by it, for example.

FIG. 1 schematically shows the design of an embodiment of a safety laser scanner 10 of a safety apparatus in accordance with the invention which is shown schematically in its totality in FIG. 2. A light beam 14 which is generated by a laser 12 and which is made up of individual light pulses is directed via a light deflection unit 16 into a field of vision 18 and is there remitted by an object which may be present. The field of vision 18 includes the total opening angle 50 (FIG. 2) of the scanner 10. Remitted light 20 arrives back at the laser scanner 10 again and is there detected by a receiver 24 via the deflection unit 16 and by means of an optical receiving system 22. The light deflection unit 16 is made rotatable as a rule, with a motor 26 continuously rotating a rotating mirror 28. The respective angular position of the rotating mirror 28 is detected via an encoder 30. The light beam 14 generated by the laser 12 thus sweeps over the field of vision 18 generated by the rotational movement. If a reflected light signal 20 received by the receiver 24 is received from the field of vision 18, a conclusion can be made on the angular location of the object in the detection region 18 from the angular position of the deflection unit 30. In addition, the transit time of the individual laser light pulses of the transmitted light 14 is monitored from the transmission up to the reception of a reflection at the object and a conclusion is drawn on the distance of the object from the laser scanner 10 from the light transit time while using the speed of light. This evaluation takes place in an evaluation unit 32 which is connected for this purpose to the laser 12, to the receiver 24, to the motor 26 and to the encoder 30. The location of the object can be determined using the indications on the angle and distance and two-dimensional monitored zones 18-1 can, for example, be completely monitored in this manner. The monitored zone 18-1 s defined in its dimensions by corresponding parameters which are stored in a memory 54 in the evaluation unit 32. If an unauthorized object is located in the monitored zone 18-1, a corresponding object detection signal can be output by the evaluation unit 32 to an output of the laser scanner 10 via a line 33 and thus ultimately a safety signal can be output to bring out a stop of a machine causing danger, for example.

Other embodiments of such a scanner are conceivable, for example scanners, which do not determine the distance on the basis of the transit time of light of individual laser pulses, but rather via triangulation or via a comparison of the phase of amplitude-modulated transmitted light with the phase of the reflected light.

All the named functional components are arranged in a housing 34 which has a front screen 36 at the front side, that is in the region of the light exit and of the light entry. The front screen 36 is set obliquely for the avoidance of direct reflections into the receiver so that the angle between the light beam 14 and the front screen 36 amounts to unequal to 90°.

FIG. 2 schematically shows the safety apparatus in accordance with the invention. It includes, in addition to the safety laser scanner 10, at least one reference target 45 which can be an individual target or also part of a reference contour 44 which is disposed outside the monitored zone 18-1 and which can comprise housing walls or the like. The reference contour 44 extends either directly at the monitored zone margin 48 or outside the monitored zone 18-1.

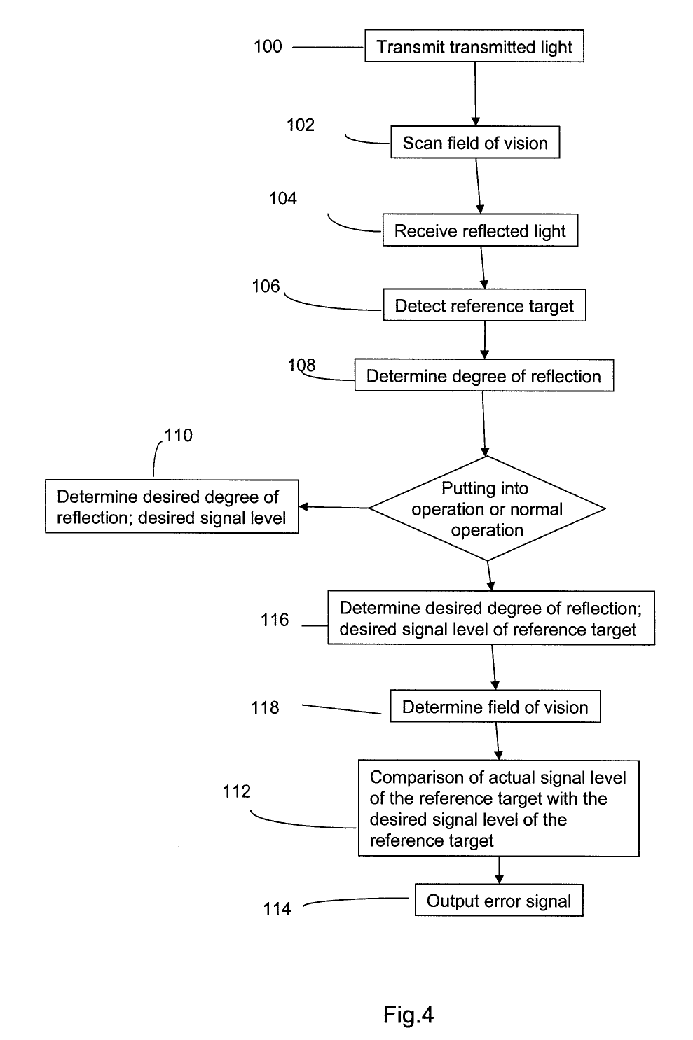

The method in accordance with the invention runs as follows, as explained schematically with reference to FIGS. 3 and 4:

In a step 100, a transmitted light beam is transmitted by the light transmitter 12. In step 102, the transmitted light beam 14 is periodically conducted through the field of vision 18 so that the monitored zone 18-1 is scanned which is part of the field of vision 18. If the object are located in the field of vision 18 of the scanner 10, the transmitted light beam 14 is reflected at these objects and the reflected light is received by the light receiver 24 (step 104). The light receiver 24 transforms the received light into electric received signals whose signal levels correspond to the received light intensities. If an unauthorized object is located in the monitored zone 18-1, a safety signal, for example a warning signal or switch-off signal, is output by the evaluation unit 32 on the line 33.

The external reference target 45, which is detected in step 106 on the scanning of the field of vision 18 by the transmitted light beam 14 is now located in the field of vision 18. The actual signal level of the reflections from the reference target 45 is detected by the light receiver and the degree of reflection of the reference target is calculated while taking account of the distance of the reference target 45 from the scanner 10 and taking account of the reception characteristic of the light receiver (step 108). When the scanner is put into operation, a desired degree of reflection is determined from this in step 110 which corresponds to a desired signal level of the reference target. In the further normal operation, the scanner then checks in step 112 whether at least the desired degree of reflection is recognized in each scan, that is whether the desired signal level of the reference target is reached or exceeded. If this is not the case, an error signal is output (step 114).

Since the degree of reflection of the reference target is not fixedly predefined and is e.g. not taught, but is rather fixed by the aforesaid calculation on the putting into operation, the safety apparatus in accordance with the invention has an exactly defined detection capability even if soft targets such as fog, rain, snow or other air pollution are present. The reference target can thus be monitored substantially more effectively. The desired signal level of the reference target, that is the received signal threshold for recognizing the reference target, can namely be determined a lot more precisely, whereby the reference target can be monitored a lot more exactly, in particular when it is a natural reference target.

In addition, the desired signal level of the reference target can be very simply adapted to the required detection task of a specific use. This would be the case, for example, if different applications having different demands on the detection capability should be performed (one would e.g. be personal protection in machine safety with 2% minimum remission recognition and predefined protected field size).

The scan's own determination of the desired degree of reflection of the reference target has the further advantage that a naturally present house wall or other articles can serve as the reference target.

A further variant is shown in FIG. 4 in which the desired degree of reflection of the reference target is determined again in a step 116 during normal operation and the visual range of the scanner 10 is determined with reference to this degree of reflection in step 118 so that the extent of the monitored zone 18-1 can be adapted in an application in dependence on the visual range. An application example for this would be, for example, collision protection at cranes. The scanner 10 could, for example, detect a suitable point of the crane if this is permanently in the field of vision of the scanner. The visual range can then be determined in dependence on the degree of reflection of this point of the crane and the movement of the crane or the size of the monitored zone can be adapted accordingly to avoid collision with the crane.

1. A method for the secure detection and position determination of objects in a monitored zone by means of an optoelectronic scanner comprising the steps of:
transmitting a transmitted light beam using a light transmitter; and
periodic scanning of a field of vision of the scanner including the monitored zone by the transmitted light beam via a deflection unit;
receiving the transmitted light beam reflected at objects in the field of vision using a light receiver and providing received signals whose signal levels correspond to the received light intensities;
outputting a safety signal (warning signal or switch-off signal) when an unpermitted object is detected in the monitored zone in that the corresponding received signal is above a received signal threshold;
providing an external reference target in the field of vision;
detecting the actual signal level of the reflections from the reference target,
calculating a desired degree of reflection of the reference target from the measured distance from the reference target, from a scanner-specific, distance-dependent reception characteristic of the light receiver and from the currently measured received signal on the reference target on the putting into operation, with the desired degree of reflection corresponding to a desired signal level of a reference target; and
outputting an error signal when a falling below of the desired signal level of the reference target is recognized during normal operation.

2. A method in accordance with claim 1, wherein a minimal degree of reflection of objects to be detected, which is taken into account during the determination of the desired degree of reflection.

3. A method in accordance with claim 2, wherein the minimal degree of reflection of objects to be detected amounts to 2%.

4. A method in accordance with claim 1, wherein the position of the reference target is monitored.

5. A method in accordance with claim 1, wherein the desired degree of reflection is periodically determined again and safety parameters such as the extent of the monitored zone are adapted in dependence thereon.

6. A method in accordance with claim 1, wherein the reference target is an object to be monitored in the monitored zone.

7. A safety apparatus for a method for the secure detection and position determination of objects in a monitored zone, the apparatus having an optoelectronic scanner, having a light transmitter for transmitting a transmitted light beam, having a deflection unit for the periodic scanning of a field of vision of the scanner including the monitored zone by the transmitted light beam, having a light receiver for receiving the transmitted light beam reflected at objects in the field of vision and for providing received signals whose signal levels correspond to the received light intensities and having an evaluation unit for processing the received signals and for outputting a safety signal (warning signal or switch-off signal) when an unpermitted object is detected in the monitored zone in that the corresponding received signal is above a received signal threshold, and having an external reference target in the field of vision, wherein the evaluation unit comprises:
a signal level determination unit for determining the actual signal level of the reflections from the reference target;
a degree of reflection determination unit for calculating a desired degree of reflection of the reference target from the measured distance from the reference target, from a scanner-specific, distance-dependent reception characteristic of the light receiver and from the currently measured received signal on the reference target;
a determination unit for determining a desired degree of reflection on the putting into operation, with the desired degree of reflection corresponding to a desired signal level of the reference target; and
an output unit for outputting an error signal when a falling below of the desired signal level of the reference target is recognized during working operation.

8. A safety apparatus in accordance with claim 7, wherein the reference target comprises at least one element mechanically bounding the monitored zone.

9. A safety apparatus in accordance with claim 7, wherein the reference target has a retroreflector.

10. A safety apparatus in accordance with claim 7, wherein the reference target is at least as large as the geometrical resolving power of the scanner.
